(19) United States
(12) Patent Application Publication
(10) Pub. No.: US 2003/0128130 A1
(43) Pub. Date: Jul. 10, 2003

(54) Solar powered radio transmission security camera

(75) Inventor: Eric Kao, Kweishan (TW)

Correspondence Address: BIRCH STEWART KOLASCH & BIRCH, PO BOX 747, FALLS CHURCH, VA, 22040-0747, US

(73) Assignee: EVERSPRING INDUSTRY CO., LTD.

(21) Appl. No.: 10/350,008

(22) Filed: Jan. 24, 2003

Related U.S. Application Data
(63) Continuation-in-part of application No. 09/996,983, filed on Nov. 30, 2001.

(51) Int. Cl. G08B 23/00

(52) U.S. Cl. 340/693.1; 340/693.5; 340/539.1; 340/541; 348/152

(57) ABSTRACT

A solar powered radio transmission security camera for Cameraing and guarding environments includes energy capturing solar cells, an electric heating detector connecting to the solar cells, a microprocessor connecting to the electric heating detector, a camera audio and video device with ON and OFF controlled by the microprocessor and a wireless transmission. The electric heating detector detects and emits control signals to the microprocessor which adjusts the ON and OFF of the camera audio and video device through signals to reduce electric energy required by the camera audio and video device thereby to reduce the size of the energy capturing solar cells and shrink the total size of the solar powered radio transmission security camera

### FIELD OF THE INVENTION

The present invention relates to a solar powered security camera with radio transmission and particularly to a solar powered radio transmission security camera that employs a passive infra-red (PIR) detection system to achieve automatic detection and control of ON and OFF to the camera system.

### BACKGROUND OF THE INVENTION

With the income of populace increases continuously, there is a growing awareness for personal security and property protection. As a result, security instrument and facility industry has flourished in recent years. These days it has been combined with electronics, communication and information technology to become a thriving new business.

The general security devices include sensors, a alarm console and an alarm siren. The sensors detect intruders and generate signals to the alarm console. The alarm console actuates the alarm siren to produce sound to warn the intruders, or sends the alarm signals to security offices or policy stations to scare off the intruders. Conventional sensors use various scientific principles such as sound, light, electricity, magnetism, or mechanical reaction to detect the presence of intruders and to generate electric current reaction to trigger the sensors. Thus the sensors are like the eyes of the system to detect various conditions. The sensors, according to the design principle, may be grouped into the types of connection/disconnection, vibration, inductance, magnetic induction, static electricity, audio wave, supersonic wave, photoelectric wave, thermal sensing, image detection, etc. Infrared light detection system is the most widely used type at present. It also has the widest guarding scope. The infrared light detection systems can be classified into active type and passive type. The active infrared employs a photoelectric device to emit infrared light to a receiver. When the light is blocked, alarm will be triggered regardless of the blocking time occurred. It is prone to generate a faulty alarm caused by the interference of external objects. Such a sensor must have two devices, one for emission and another for receiving. The two devices are coupled to form a detection line. The passive infrared light does not need the transmission and receiving devices like the active one. It detects alteration of the infrared radiation caused by the movement of human being to trigger the alarm. For instance, U.S. Pat. No. 6,441,731 discloses a passive infrared motion sensor 50 for an alarm transmission device. However, the infrared detection system has to monitor the guarding area for a long period of time, which will cause the sensors and CCTV Camera system consume a great amount of power. U.S. Pat. No. 6,127,926 discloses a solar panel 20 which provides power required by the security system. Although U.S. Pat. No. 6,127,926 begin to use solar energy on the infrared security system, to meet the requirement of continuous monitoring of the infrared sensors for a long period of time. However, it requires a large solar panel to collect the required energy or otherwise an additional power supply must be provided. As a result, the size of the security device is bulky and installation location is restricted. Hence at present the solar infrared security device is still not widely accepted by the general public.

### SUMMARY OF THE INVENTION

Therefore the primary object of the invention is to solve the aforesaid disadvantages. The invention provides a passive infrared detection system with an inner control circuit to adjust ON and OFF of a Camera system to save power consumption. Hence the size of the solar energy collection panel can be shrunk significantly, and the solar powered radio transmission security camera become more practicable.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an operational block diagram of the invention.

FIG. 2 is the process flow chart of the detection system of the invention.

FIG. 3 is a pictorial view of an embodiment of the invention.

### DESCRIPTION OF THE PREFERRED EMBODIMENT

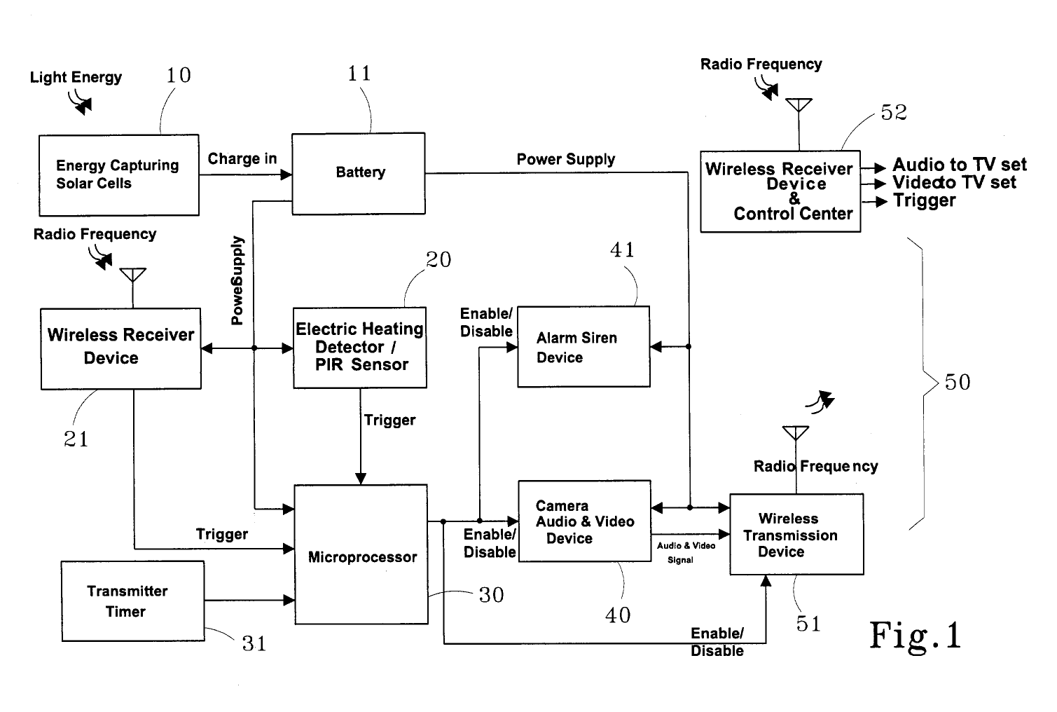

Referring to FIG. 1, the solar powered wireless radio transmission security camera of the invention includes energy capturing solar cells 10, an electric heating detector 20 connecting to the solar cells 10, a microprocessor 30 connecting to the electric heating detector 20, a camera audio and video device 40 with ON and OFF controlled by the microprocessor 30 and a wireless transmission 51.

The energy capturing solar cells 10 can transform solar energy to electric power and store in a battery 11. The battery 11 supplies the electric power required by the security camera and stores extra electric power to be used when weather is not good. The battery 11 provides electric power to the electric heating detector 20, microprocessor 30, camera audio and video device 40, wireless transmission 51, an alarm siren device 41 and a second wireless receiver device 21. When the electric power of the battery 11 is less than the power required by the system, the microprocessor 30 and an indoor second wireless receiver device 52 will generate a warning signal or automatically shorten signal transmission time.

The electric heating detector 20 is a passive infra-red (PIR) detection system to detect intruders and generate a control signal to the microprocessor 30. The microprocessor 30 transmits the signal to the camera audio and video device 40 or the alarm siren device 41, and the alarm siren device 41 generates sound to achieve scaring effect, or the camera audio and video device 40 transmits the signal to the wireless transmission 51 which transmits the audio, video or triggered signal to the indoor second wireless receiver device 52. The indoor second wireless receiver device 52 may output audio and video images on the display device, or the triggered signal may be sent to security units to do necessary process. During the standby state, the wireless transmission 51 shuts down the radio wave to prevent interference on other users. Moreover, the wireless receiver device 21, besides receiving a PIR device trigger signal, may also receive a smoke detector, door and window sensor and fire detector trigger signal. Signal transmission is same as what has been discussed previously. Details are omitted.

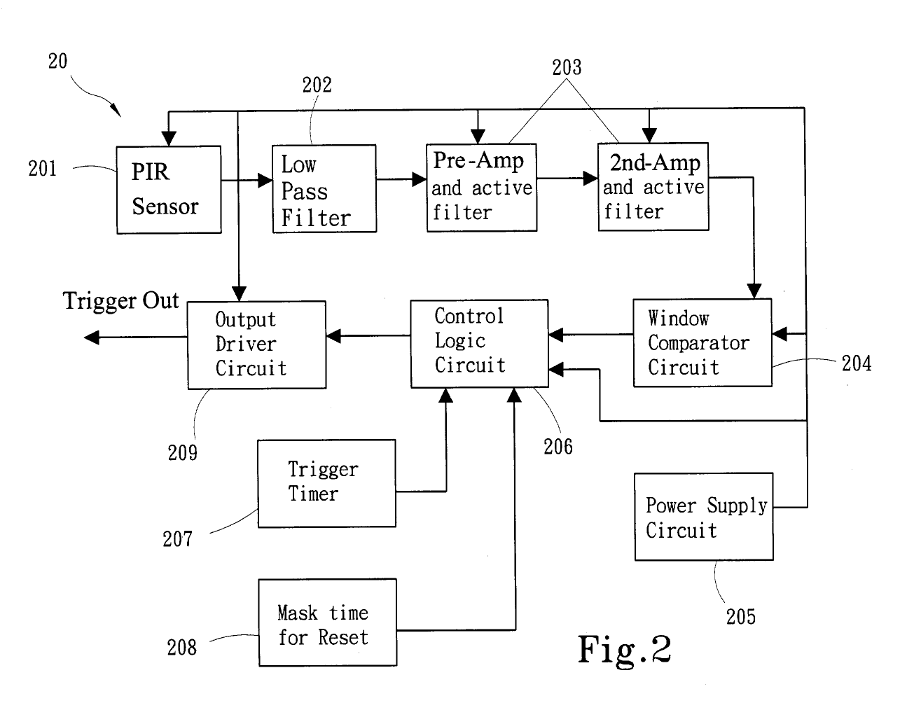

Refer to FIG. 2 for the process flow of the detection system of the invention. The electric heating detector 20 is a PIR detection system, and includes a PIR sensor 201, a power supply circuit 205, a control logic circuit 206 and an output driver circuit 209. There are a low pass filter 202, a pre-amp and active filter and a second-amp and active filter 203, and a window comparator circuit 204 located between the PIR sensor 201 and the control logic circuit 206. In addition, the control logic circuit 206 has a trigger timer 207 and a mask time for reset 208.

The PIR sensor 201 is a passive infrared sensor which uses thermal difference principle to generate a DC potential and transmit to the low pass filter 202. The low pass filter 202 filters out noise signals to clean the signals detected by the PIR sensor 201 for transmitting to the pre-amp and active filter and the second-amp and active filter 203. The pre-amp and active filter and the second-amp and active filter 203 amplify the signal of the PIR sensor 201 to increase the sensitivity. The amplified signal is sifted by the window comparator circuit 204 and sent to the control logic circuit 206 for processing. The control logic circuit 206 may be controlled by the trigger timer 207 to adjust the transmission time of the triggered signal. The control logic circuit 206 also is connected to the mask time for reset 208 to maintain the stability at the initial state. The signal passing through the control logic circuit 206 is transformed by the output driver circuit 209 to drive other elements. The power supply of the electric heating detector 20 is provided by the power supply circuit 205.

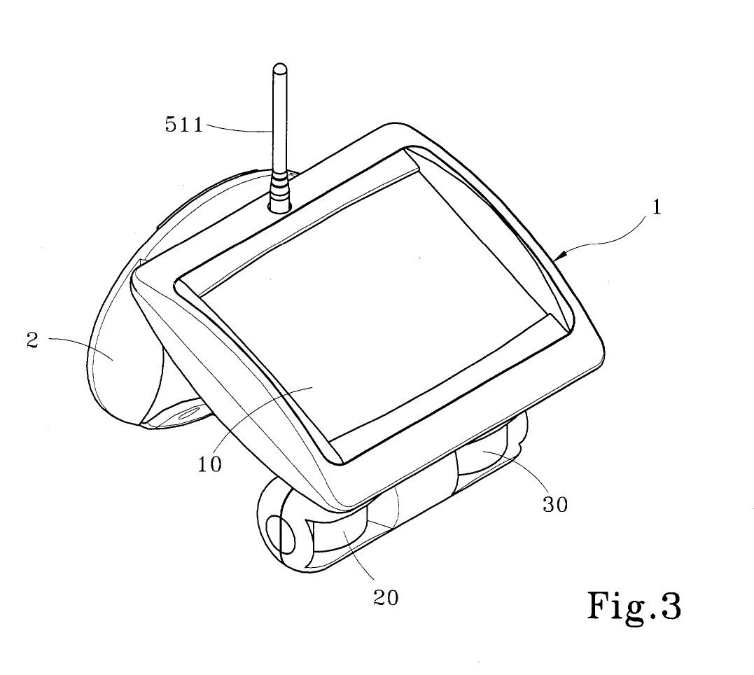

Refer to FIG. 3 for an embodiment of the invention. The solar powered radio transmission security camera of the invention includes energy capturing solar cells 10 to transform solar energy to electric energy, an electric heating detector 20 connecting to the solar cells 10 to detect intruders and generate signals, and a microprocessor (not shown in the drawing) connecting to the electric heating detector 20 to receive the signals emitted from the electric heating detector 20, a camera audio and video device 30 with ON and OFF controlled by the microprocessor and a directionless antenna 511. It has a wider receiving and transmission range. The rear end of the security camera 1 has a fastening section 2 for installing the security camera 1 on a selected location. The various elements of the invention may also be installed separately without affecting the actual operation.

What is claimed is:

1. A solar powered radio transmission security camera for monitoring and guarding environments comprising energy capturing solar cells, an electric heating detector connecting to the solar cells, a microprocessor connecting to the electric heating detector, a camera audio and video device with ON and OFF controlled by the microprocessor and a wireless transmission, wherein the electric heating detector detects and emits control signals to the microprocessor which adjusts the ON and OFF of the camera audio and video device thereby to reduce power consumption required by the camera audio and video device and to reduce the size of the energy capturing solar cells and shrink the total size of the solar powered radio transmission security camera.

2. The solar powered radio transmission security camera of claim 1, wherein the electric heating detector is a passive infrared detection system which includes a passive infrared sensor, a power supply circuit, a control logic circuit and an output driver circuit.

3. The solar powered radio transmission security camera of claim 2 further having a low pass filter, a pre-amp and active filter and a second-amp and active filter, and a window comparator circuit located between the passive infrared sensor and the control logic circuit.

4. The solar powered radio transmission security camera of claim 2, wherein the control logic circuit has a trigger timer.

5. The solar powered radio transmission security camera of claim 1, wherein the microprocessor includes a timer 31 to transmit on and off signal to activate or close the camera audio and video device.

6. The solar powered radio transmission security camera of claim 1 further has a battery to store the energy of the energy capturing solar cells.

7. The solar powered radio transmission security camera of claim 6, wherein the microprocessor generates a warning signal and automatically shortens the radio transmission time when the electric power of the battery is less than the power required by the power supply circuit.

8. The solar powered radio transmission security camera of claim 1 further having an alarm system.

9. The solar powered radio transmission security camera of claim 1 could further receiving signal from the second detection system for detecting trigger signal from intruders, smoke, doors opening, windows opening and fire.

10. The solar powered radio transmission security camera of claim 9, wherein the wireless receiver device receives the detected signal from the second detecting system and notifies the microprocessor to react immediately.

11. The solar powered radio transmission security camera of claim 1, wherein the energy capturing solar cells and the entire system is water-proof for installing outdoors and to be used for a desired time period.

12. The solar powered radio transmission security camera of claim 1, wherein the camera audio and video device includes a video camera, an image processing device and a transmission element.

13. The solar powered radio transmission security camera of claim 1, wherein the wireless transmission system includes a wireless transmission unit and a wireless receiving unit, the wireless transmission unit transmitting sound, images and driving signals to the wireless receiving unit which outputs the sound, images or driving signals.

14. The solar powered radio transmission security camera of claim 1, wherein the wireless transmission has a directionless antenna.

15. The solar powered radio transmission security camera of claim 1, wherein the wireless transmission stops radio wave during a standby state to prevent interfering other users.

16. The solar powered radio transmission security camera of claim 1 further having a remote control unit for monitoring a guarding area instantly.
